(19) United States
(12) Patent Application Publication
(10) Pub. No.: US 2020/0354279 A1
(43) Pub. Date: Nov. 12, 2020

(54) CERAMIC MATERIAL COMPOSITE COMPRISING A BONDING LAYER OF A MOLYBDENUM-TITANIUM CARBIDE COMPOSITE MATERIAL, COMPONENT, GAS TURBINE, AND METHOD

(71) Applicant: SIEMENS AKTIENGESELLSCHAFT, München (DE)

(72) Inventors: Jens Dahl Jensen, Berlin (DE); Oliver Stier, Berlin (DE); Gabriele Winkler, Berlin (DE)

(21) Appl. No.: 16/962,648

(22) PCT Filed: Jan. 14, 2019
(86) PCT No.: PCT/EP2019/050738

§ 371 Date: Jul. 16, 2020

(30) Foreign Application Priority Data
Jan. 17, 2018 (EP) 18152107.1

(51) Int. Cl. C04B 37/00; C04B 35/48; F01D 5/28

(52) U.S. Cl. CPC C04B 37/005; C04B 35/48; F01D 5/284; F01D 5/282; C04B 2235/3246; F01D 25/005; C04B 2237/083; C04B 2237/38; C04B 2237/348; C04B 2237/72; C04B 2237/064

(57) ABSTRACT

A material composite is provided, wherein the material composite includes a first layer formed at least of a ceramic first material, and a second layer arranged on the first layer and formed at least of a ceramic second material that is different from the first material. In order to achieve a higher thermal and/or mechanical load capacity, the material composite further includes a connection layer arranged between the first layer and the second layer, and connects the first layer to the second layer. The connection layer is formed at least partially of a molybdenum-titanium carbide composite material.

The present patent document is a § 371 nationalization of PCT Application Serial No. PCT/EP2019/050738, filed Jan. 14, 2019, designating the United States, which is hereby incorporated by reference, and this patent document also claims the benefit of European Patent Application No. 18152107.1, filed Jan. 17, 2018, which is also hereby incorporated by reference.

### TECHNICAL FIELD

A first aspect of the disclosure relates to a material composite including a first layer of a first ceramic material and a second layer of a second ceramic material. A second aspect of the disclosure relates to a component including such a material composite. A third aspect of the disclosure relates to a gas turbine including such a component. A fourth aspect of the disclosure relates to a method for the production of such a material composite.

### BACKGROUND

In high-temperature applications, (e.g., in a gas turbine), components including a metal alloy may be used that are protected from thermal overloading by a ceramic material. For example, a component for a high-temperature application may include a metallic carrier body that is coated with a ceramic material. By such a thermal barrier layer, which is composed of the ceramic material, the thermal load capacity of the component may be increased. This may be advantageous in gas turbines, in which a higher combustion temperature is made possible by increasing the thermal load capacity of components. The increase in the combustion temperature increases the thermodynamic efficiency of the gas turbine, which may result in reduced fuel consumption and pollutant emission.

The thermal load capacity may be increased to a particular degree if the thermal barrier layer is composed of a material composite of two different ceramic materials. This material composite may include a first layer of a first ceramic material and a second layer of a second ceramic material. It is problematic that the first material and the second material may have different thermal expansion coefficients or other deviating mechanical properties. This may lead in mechanical or thermal loading to spray breaks in the material composite. This applies in particular because ceramic materials may be highly brittle. SUMMARY AND DESCRIPTION

The object of the present disclosure is to increase the mechanical and/or thermal load capacity of an above-mentioned material composite.

The scope of the present disclosure is defined solely by the appended claims and is not affected to any degree by the statements within this summary. The present embodiments may obviate one or more of the drawbacks or limitations in the related art.

The disclosure relates to a material composite including a first layer composed at least of a first ceramic material and a second layer arranged on the first layer composed at least of a second ceramic material that is different from the first material. The first layer and the second layer may each be extended in a flat configuration. This means that the thickness of the first layer and/or the second layer is low compared to its extension along two spatial directions perpendicular to the thickness. In this context, in particular, the term ‘low’ means that there is a factor of at least 10, at least 100 or at least 1000 between the thickness of the first layer or the second layer and each of the spatial directions perpendicular to the thickness.

In order to achieve a higher thermal and/or mechanical load capacity, a bonding layer is arranged between the first layer and the second layer and is at least partially composed of a molybdenum-titanium carbide composite material, by which the first layer is connected to the second layer. In other words, the first layer is connected to the second layer by a bonding layer, wherein the bonding layer is composed at least partially of a molybdenum-titanium carbide composite material. In some embodiments, the bonding layer is exclusively composed of the molybdenum-titanium carbide composite material. In other embodiments, the bonding layer is composed of a material mixture that includes the molybdenum-titanium carbide composite material and at least a further material. The molybdenum-titanium carbide composite material is characterized by plastic extensibility of up to 10 percent at room temperature, unlimited compressive ductility up to more than 1200° C., and a high thermal load capacity. In a sense, the molybdenum-titanium carbide composite material is therefore an “elastic ceramic.” Therefore, an elastic but thermally loadable bonding layer is arranged between the first layer and the second layer. Because of its elasticity or ductility, the bonding layer makes it possible to absorb stresses between the first layer and the second layer that may result from the differing thermal expansion coefficients. In this manner, the bonding layer allows the thermal and/or mechanical load capacity of the material composite to be improved compared to the prior art.

In particular, it is provided that the bonding layer comes into direct contact with both the first layer and the second layer. In other words, the bonding layer is arranged between the first layer and the second layer and is in direct mechanical contact with both the first layer and the second layer. In particular, there are no air inclusions between the first layer and the bonding layer and/or between the bonding layer and the second layer, respectively. This structure makes the material composite particularly compact.

According to an improvement, it is provided that the bonding layer is connected both to the first layer and to the second layer via at least one cohesive bond, respectively. In other words, the first layer is solidly connected to the bonding layer by atomic or molecular forces. In addition, the bonding layer is connected to the second layer via atomic or molecular forces. The respective cohesive bond is not necessarily direct. This means that the bonding layer may be connected to the first layer and/or the second layer via an intermediate layer by two cohesive bonds. Accordingly, the first layer and the second layer are also materially connected to each other indirectly, e.g., at least via a bonding layer. This gives rise to a particularly stable structure of the material composite. In addition, thus may also further increase the mechanical load capacity.

According to some embodiments, the bonding layer is bonded to the first layer and/or the second layer by a direct cohesive bond. In other words, the bonding layer is in direct mechanical contact with the first layer and/or the second layer, wherein a cohesive bond is formed at a respective contact surface. To put it yet another way, the bonding layer is in direct contact with the first layer and/or the second layer, wherein a cohesive bond is formed at a respective contact surface. This allows the mechanical load capacity to be further increased.

According to an improvement, a first diffusion barrier is arranged between the first layer and the bonding layer and/or a second diffusion barrier is arranged between the second layer and the bonding layer. In other words, the material composite may include the first diffusion barrier between the first layer and the bonding layer. Alternatively, or additionally, the material composite may include the second diffusion barrier between the second layer and the bonding layer. The respective diffusion barrier may form one of the above-mentioned intermediate layers. In other words, the first layer may be indirectly connected in a cohesive manner via the first diffusion barrier by two cohesive bonds. Alternatively, or additionally, the second layer may be indirectly connected to the bonding layer in a cohesive manner via the second diffusion barrier by two cohesive bonds. By the first diffusion barrier and/or the second diffusion barrier, the bonding layer may be protected from chemical reactions, in particular oxidation. In other words, the first diffusion barrier and/or the second diffusion barrier may be configured for this purpose to block the penetration of reagents, (e.g., oxygen), into the bonding layer.

For this purpose, the first diffusion barrier and/or the second diffusion barrier may be composed at least of aluminum oxide. In other words, the first diffusion barrier and/or the second diffusion barrier may be composed of a material mixture for the diffusion barrier that includes aluminum oxide and a further material. Alternatively, the first diffusion barrier and/or the second diffusion barrier may be composed exclusively of aluminum oxide. A diffusion barrier composed of aluminum oxide provides particularly economical and effective protection against oxidation.

According to an improvement, it is provided that the first diffusion barrier is applied to the first layer by atomic layer deposition and/or the second diffusion barrier is applied to the bonding layer by atomic layer deposition. In other words, the first layer may be coated with the first diffusion barrier by atomic layer deposition. Alternatively, or additionally, the bonding layer may be coated with the second diffusion barrier by atomic layer deposition. The principle of atomic layer deposition allows the respective diffusion barrier to have a particularly homogeneous and impurity-free structure, have a particularly defined thickness, be particularly thin and/or have a particularly defect-free crystal structure. This allows the mechanical or chemical properties of the respective diffusion barrier to be improved and/or the diffusion of the reagents, (e.g., oxygen), to be blocked in a particularly favorable manner.

According to an improvement, it is provided that the first material is a ceramic fiber composite that in particular is composed at least of ceramic fibers of a ceramic matrix in which the fibers are embedded. The first material may therefore be a ceramic fiber composite that is also referred to using the English technical term ceramic matrix composite, abbreviated CMC. For example, the fiber composite material has an inner structure that is composed of the ceramic fibers and the ceramic matrix. The fibers may be embedded in the matrix. In other words, the fibers may be enclosed by the matrix. For example, the fibers may be mullite fibers. Mullite is a mixture of aluminum oxide and silicon oxide. The matrix may be composed at least of aluminum oxide, silicon oxide, or a mixture of aluminum oxide and silicon oxide. Such fiber composite materials are characterized by a high mechanical and thermal load capacity.

An improvement provides that the second material has a higher heat resistance and/or corrosion resistance than the first material. Accordingly, the second layer may have a higher heat resistance and/or corrosion resistance than the first layer. The second layer may thus be configured as a heat shield or corrosion protection for the first layer. Because the second layer or the second material has the higher heat resistance and/or corrosion resistance, the resistance of the material composite to thermal loads and/or corrosion as a whole may be further improved.

According to an improvement, the second material is composed of yttrium-stabilized zirconium oxide. Yttrium-stabilized zirconium oxide shows a particularly high thermal load capacity. Because the second layer is composed at least of yttrium-stabilized zirconium oxide, this may give rise to an additionally increased thermal load capacity of the material composite.

A second aspect of the disclosure relates to a component that is composed at least of the material composite described above and below. In other words, the component is at least partially produced from the above-mentioned material composite. In this manner, a component for high-temperature applications may be provided that shows an improved thermal and/or mechanical load capacity.

According to an improvement, the component includes at least a carrier body that is at least partially provided with the material composite as a heat shield. In other words, the carrier body may form a basic skeleton of the component. This basic skeleton or the carrier body may be at least partially provided or coated with the material composite as a heat shield. The material composite or the heat shield is configured to protect the carrier body from thermal loading. For this purpose, the material composite or the heat shield may be arranged on the carrier body as a thermal insulator. By combining the at least one carrier body with the material composite as a heat shield, the component may be configured to be particularly light and/or stable on the one hand, and it may have particularly high thermal load capacity on the other.

An improvement provides that the carrier body is composed of a third material that is different from the first and the second materials, (e.g., a metallic material). The metallic material may be a metallic alloy, e.g., a so-called superalloy. Metallic materials, (e.g., metallic alloys), are characterized by high stability combined with light weight. By combining the metallic carrier body with the material composite, a component may be provided that is even lighter and/or more stable and nevertheless has a particularly high thermal load capacity. The third material may be a nickel or cobalt superalloy.

Such a component is particularly well-suited for use in a gas turbine. A third aspect therefore relates to a gas turbine with a component described above and below. In particular, the component of the gas turbine is a component having a particularly high thermal load capacity. The high thermal load capacity allows the combustion temperature of the gas turbine to be increased compared to the prior art. This increased combustion temperature results in increased thermodynamic efficiency. The increased efficiency may give rise to reduced fuel consumption and thus reduced emission of pollutants.

A further aspect of the disclosure relates to a method for the production of a material composite including a first layer of at least a first ceramic material and a second layer arranged on the first layer composed at least of a second ceramic material that is different from the first material. In this method, the second layer is thus arranged on the first layer.

According to the disclosure, a bonding layer composed at least partially of a molybdenum-titanium carbide composite material is arranged between the first layer and the second layer, by which the first layer is connected to the second layer. In other words, the first layer and the second layer are connected to each other by the bonding layer.

In a further embodiment, the bonding layer may be formed by applying the molybdenum-titanium carbide composite material to the first layer or arranging it thereon. The first layer may be coated with the bonding layer. The molybdenum-titanium carbide composite material may be applied to or arranged on the first layer by cold gas spraying. According to this principle, the molybdenum-titanium carbide composite material does not undergo any phase transition or oxidation. The process temperature of approximately 1100° C. is far below the melting temperature of the molybdenum-titanium carbide composite material of over 2600° C. In cold gas spraying, the particles strike the respective substrate, here the first layer, in an inert gas stream. This allows the purity of the molybdenum-titanium carbide composite material to be maintained. Advantageously, the molybdenum-titanium carbide composite material is applied to or arranged on the substrate, here the first layer, in the form of porous powder particles. The porous powder particles may be pre-formed from molybdenum microparticles and titanium carbide microparticles having a size of a few micrometers (μm) or less than 1 Because of the porosity of the powder particles, they collapse on impacting the substrate, here the first layer, with the result that the substrate is not damaged.

For example, it is provided that the microparticles of the molybdenum-titanium carbide composite material have a porosity of at least 5 percent, at least 10 percent, at least 20 percent, at least 40 percent or at least 60 percent by volume.

According to an improvement, it is provided that a first diffusion barrier is arranged between the first layer and the bonding layer and/or a second diffusion barrier is arranged between the second layer and the bonding layer. For example, the first diffusion barrier is applied to or arranged on the first layer. In other words, the first layer may be coated with the first diffusion barrier. In this case, the bonding layer is applied to or arranged on the diffusion barrier rather than the first layer. In this case, the substrate for the cold gas spraying of the bonding layer is therefore the first diffusion barrier rather than the first layer.

Optionally, the second diffusion barrier may be arranged on the bonding layer. In particular, the bonding layer is coated with the second diffusion barrier. The second diffusion barrier may be applied to or arranged on the bonding layer.

According to an improvement, it is provided that the first diffusion barrier is deposited on the first layer by atomic layer deposition and/or the second diffusion barrier is applied to the bonding layer by atomic layer deposition. In other words, the coating of the first layer with the first diffusion barrier takes place by atomic layer deposition and/or the coating of the bonding layer with the second diffusion barrier takes place by atomic layer deposition. By the principle of atomic layer deposition, a particularly homogeneous and impurity-free structure, a particularly defined layer thickness, a particularly low or thin layer thickness and/or a particularly defect-free crystal structure may be achieved for the respective diffusion barrier. This makes it possible to improve the mechanical or chemical properties of the respective diffusion barrier and/or to prevent diffusion of the reagents, in particular oxygen, in a particularly favorable manner.

### BRIEF DESCRIPTION OF THE DRAWINGS

The figures show the following:

FIG. 1 depicts a cutaway view of an example of a schematic cross-section through a material composite.

FIG. 2 depicts a highly schematic view of an example of a gas turbine.

### DETAILED DESCRIPTION

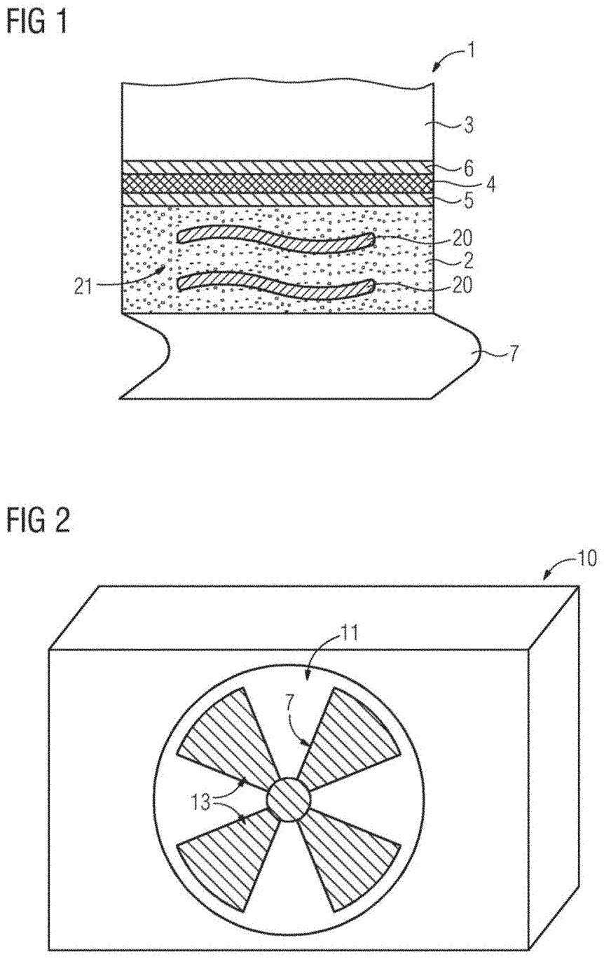

FIG. 1 shows a material composite 1 in a highly schematic sectional view. Here, the material composite 1 is arranged on a carrier body 7. The material composite 1 includes a first layer 2 and a second layer 3, wherein the second layer 3 is arranged over the first layer 2. The first layer 2 is composed at least of a first ceramic material. In the present example, the first layer is composed exclusively of the first ceramic material. The second layer 3 is composed at least of a second ceramic material that is different from the first material. In other words, the second material is a ceramic material that is different from the first material. The first material and the second material are therefore different ceramics. In the present example, the second layer 3 is composed exclusively of the second material.

In the present example, the first material is a ceramic fiber composite material. The ceramic fiber composite material includes ceramic fibers 20 and a ceramic matrix 21 in which the fibers 20 are embedded. In other words, the fiber composite material includes the matrix 21 and the fibers 20, wherein the fibers 20 are enclosed by the matrix 21. The fibers 20 may be mullite fibers. The mullite fibers may be spun fibers composed of aluminum oxide (Al₂O₃) and silicon oxide (SiO₂). The matrix 21 may be composed of aluminum oxide and/or silicon oxide. In the present example, the matrix 21 is composed of aluminum oxide, as this configuration is more favorable for production.

Here, the second material is yttrium-stabilized zirconium oxide. In other words, the second layer 3 is composed at least of yttrium-stabilized zirconium oxide. In the present example, the second layer 3 is composed exclusively of yttrium-stabilized zirconium oxide. It may be advantageous for the second material to have a higher heat resistance and/or corrosion resistance than the first material. This applies in particular to yttrium-stabilized zirconium oxide. It is thus possible, by arranging the second layer 3 over the first layer 2, to increase the thermal load capacity of the material composite 1, in particular compared to use of the first layer 2 alone.

Here, both the first layer 2 and the second layer 3 are brittle, which means that they show low ductility or elasticity. In the case of mechanical or thermal loading, this may lead to stresses between the first layer 2 and the second layer 3 if they are arranged directly atop each other, e.g., are in contact with each other. Stresses resulting from thermal loading may occur if the first layer 2 and the second layer 3 have different thermal expansion coefficients. For this reason, a bonding layer 4 is arranged between the first layer 2 and the second layer 3. The bonding layer 4 advantageously shows elastic properties. In this manner, stresses between the first layer 2 and the second layer 3 may be absorbed by elastic or ductile deformation of the bonding layer 4. This may result in an improved thermal and/or mechanical load capacity of the material. However, it is necessary for the bonding layer 4 to have a sufficient thermal load capacity for this purpose, and in particular for it to retain its elasticity or ductility even under high thermal loading. For high-temperature applications, it may be necessary for the bonding layer to retain its elastic or ductile character at temperatures greater than 1000° C., 1200° C., or 1400° C. In the present example, it was also realized that molybdenum-titanium carbide composites may meet this requirement. The bonding layer 4 is therefore composed at least of a molybdenum-titanium carbide composite material. In the present example, the bonding layer 4 is produced exclusively from the molybdenum-titanium carbide composite material. Advantageously, the bonding layer 4 is at least indirectly connected by a cohesive bond both to the first layer 2 and the second layer 3. For example, the bonding layer 4 may be in contact with the first layer 2 and be directly connected to it by a cohesive bond. Alternatively, or additionally, the bonding layer 4 may be in contact with the second layer 3 and be connected thereto by a cohesive bond.

In the present example, a first diffusion barrier 5 is arranged between the first layer 2 and the bonding layer 4. The first diffusion barrier 5 is directly connected to the bonding layer 4 and the first layer 2 respectively by cohesive bonds. In other words, the first diffusion barrier 5 is in contact with both the bonding layer 4 and the first layer 2 and has respective cohesive bonds at the respective contact surfaces. As a result, the bonding layer 4 is indirectly, e.g., via the first diffusion barrier 5, connected to the first layer 2 by a cohesive bond. Here, a second diffusion barrier 6 is arranged between the bonding layer 4 and the second layer 3. The second diffusion barrier 6 is connected to the bonding layer 4 and the second layer 3 by a cohesive bond. The second diffusion barrier 6 is in contact both with the bonding layer 4 and with the second layer 3 and has respective cohesive bonds at the respective contact surfaces. In this example, therefore, the bonding layer 4 is indirectly, e.g., via the second diffusion barrier 6, connected to the second layer 3 by a cohesive bond.

The optional first diffusion barrier 5 and/or the optional second diffusion barrier 6 respectively are configured to block the penetration or diffusion of harmful reagents into the bonding layer 4. In particular, the diffusion barriers 5 and 6 are configured to block the penetration or diffusion of oxygen into the bonding layer 4. In this manner, the diffusion barriers 5, 6 may prevent undesired chemical reactions, in particular oxidation, in the bonding layer 4. This is particularly important in cases where the bonding layer 4 includes yttrium-stabilized zirconium oxide, as this substance oxidizes under the influence of oxygen and may lose its elastic or ductile properties. The first diffusion barrier 5 and/or the second diffusion barrier 6 respectively may be produced from aluminum oxide.

One may dispense with the first diffusion barrier 5 in cases where penetration of the undesired reagents, (e.g., oxygen), is already sufficiently prevented by the first layer 2. Analogously, one may dispense with the second diffusion barrier 6 in cases where penetration of the undesired reagents, (e.g., oxygen), is already sufficiently prevented by the second layer 3.

In the present example, the material composite 1 or the first layer 2 is arranged on the carrier body 7. The carrier body 7 may be composed at least of a third material that is different from the first material and the second material. In the present example, the third material is a metal or a metallic alloy. The carrier body 7 and the material composite 1 may be part of a component 11. By the present arrangement, the component 11 may show a particularly high thermal load capacity compared to other components. In particular, the material composite 1 forms a thermal barrier layer on the carrier body 7. The material composite 1 forms a heat shield 13 for the carrier body 7. Inside the material composite 1, the first layer 2 and the second layer 3 respectively form partial insulating layers. For this reason, the second layer 3 has a higher thermal load capacity than the first layer 2. The first layer 2 in turn may have a higher thermal load capacity than the carrier body 7.

For example, the second layer 3 may have a thickness of approximately 300 μm. The second layer 3 may be referred to using the English technical term thermal barrier coating, abbreviated as TBC, which is translated into German as “Warmedammungsbeschichtung [thermal barrier coating].” Such thermal barrier coatings are known to the person skilled in the art. The second diffusion barrier 6 and the first diffusion barrier 5 may each have a thickness of approximately 100 nm. The bonding layer may advantageously have a thickness of approximately 300 to 500 μm. The first layer 2 may have a thickness of approximately 3 to 5 mm.

In producing the material composite 1, the first diffusion barrier 5 may first be arranged on the first layer 2 or applied to the first layer 2. In other words, the first layer 2 may first be coated with the first diffusion barrier 5. The coating or arrangement of the first diffusion barrier 5 may take place by atomic layer deposition. Atomic layer deposition allows a particularly thin layer thickness, a particularly highly defined layer thickness, and a particularly defect-free and uniform distribution of the first diffusion barrier 5 on the first layer 2 to be achieved.

The molybdenum-titanium carbide composite material is then arranged on the first diffusion barrier 5. In an embodiment of the material composite 1, if no first diffusion barrier 5 is provided, the bonding layer 4 is applied to the first layer 2 or arranged on the first layer 2. In other words, either the first layer 2 or the first diffusion barrier 5 is coated with the bonding layer 4. The arrangement of the bonding layer 4 or the coating with the bonding layer 4 advantageously takes place by cold gas spraying. This method is particularly advantageous as the composite material does not undergo any phase transition or oxidation in this coating process. At a maximum of about 1100° C., the process temperature is far below the melting temperature of the composite material of more than 2600° C. Particles of the bonding layer 4 strike the respective surface (e.g., first layer 2 or first diffusion barrier 5) in an inert gas stream. Porous powder particles of the molybdenum-titanium carbide composite material are applied to the respective surface. Because of their porosity, these powder particles are plastically deformable. The powder particles are produced from molybdenum and titanium carbide-microparticles of μm or sub-μm size.

These molybdenum and titanium carbide microparticles may be produced by milling titanium carbide and molybdenum particles in alcohol for approximately two hours. After the alcohol evaporates, the mixed powder may be subjected to cold isostatic pressing at 2500 bar for one minute. An outgassing process is then carried out at 600° C. for 12 hours under a high vacuum. This is followed by a sintering process at 1600° C. and 1610 MPa by hot isostatic pressing. A core of the molybdenum-titanium carbide composite material is composed of titanium carbide and enclosed by a (Mo, Ti)C envelope. The (Mo, Ti)C phase is generated by diffusion of molybdenum into the titanium carbide.

The porous molybdenum-titanium carbide particles are applied to the respective surface at high speed. For this purpose, process gas, (e.g., nitrogen), forming gas, helium, or a mixture thereof, is heated under high pressure to several 100° C. and depressurized in a de Laval nozzle. The convergent-divergent nozzle shape causes the process gas to accelerate to ultrasonic speed. Before entering the nozzle, the molybdenum-titanium carbide particles are dosed into the hot process gas jet. The injected particles are heated and accelerated using the exiting gas jet to such a high speed that without previous on-melting or fusion, they adhere firmly to the surface on impact and form a dense layer having a thickness of several 100 μm. If the surface is the first diffusion barrier 5, the particles of the first diffusion barrier 5 may additionally be bound to one another in this process.

Of central importance in this cold gas spraying is the porous structure of the molybdenum-titanium carbide powder particles, which collapse on impacting the surface. When the particles collapse, rapid sliding of the microparticles making up the individual powder particles occurs inside said powder particles. In this process, the metallic components (molybdenum, Mo) undergo cold bonding and embed a brittle phase of titanium carbide (TiC) into a newly formed solid body (e.g., the bonding layer 4). Binding to the surface, (e.g., the first diffusion barrier 5), takes place by sliding of the crystal planes in order to absorb the input kinetic energy. If the powder particles were solid rather than porous, they would destroy the surface in the form of barely-deformable projectiles. Because of their porous inner structure, however, the powder particles act as a deformation zone. The combining of the molybdenum and titanium carbide microparticles serves to bond them into heavier units, e.g., the powder particles, which due to their greater inertia are capable of penetrating a high-pressure front in front of the material surface in order to reach said surface. Individually, the molybdenum and titanium microparticles would be less dangerous to the surface but would be practically incapable of reaching the surface because the molybdenum and titanium microparticles would follow the gas in a vortex flow in front of the surface.

The forming gas, (e.g., composed of 95 mol % nitrogen and 5 mol % hydrogen), is particularly well-suited as a process gas for coating with molybdenum-titanium carbide powder particles, as the hydrogen exerts a reducing action on the molybdenum and prevents oxide formation during the deposition process.

In order to protect the molybdenum in the bonding layer 4, the second diffusion barrier 6 is then advantageously arranged on the bonding layer 4. In other words, the bonding layer 4 is coated with the second diffusion barrier 6. As the application or arrangement of the second diffusion barrier 6 takes place analogously to the application or arrangement of the first diffusion barrier 5, this will not be described again here. Of course, this also applies correspondingly in cases where no first diffusion barrier 5 is provided.

The second layer 3 may then be applied to the bonding layer 4 or the second diffusion barrier 6 or arranged thereon. In other words, the bonding layer 4 or the second diffusion barrier 6 may be coated with the second layer 3. Atmospheric plasma spraying is particularly well-suited for this purpose. The yttrium-stabilized zirconium oxide may be arranged by the atmospheric plasma spraying on the bonding layer 4 or the second diffusion barrier 6.

By way of example, FIG. 2 shows a highly schematic view of a gas turbine 10. The gas turbine 10 has a component 11 that includes a carrier body 7 of a metallic alloy and a heat shield 13. The material composite 1 or the heat shield 13 are configured to protect the carrier body 7 from thermal loading resulting from combustion of fuel in the gas turbine 10. Thanks to the heat shield 13, it is possible to operate the gas turbine 10 at a combustion temperature of more than 1400° C., more than 1600° C. or even higher, which allows higher efficiency compared to a lower combustion temperature. The higher efficiency allows the pollutant emission of the gas turbine 10 to be reduced. Moreover, operation of the gas turbine 10 is more efficient and economical compared to a gas turbine having lower efficiency.

Examples of components 11 of the gas turbine 10 that may be protected by the heat shield 13 composed of the material composite 1 include combustion chambers, transition channels, guide vanes, and ring segments. Moreover, the use of hydrogen-free fuel or combustion gas is also possible in operation of such a gas turbine 10, because the composite composed of the first layer 2 and the second layer 3 protects the component 11 of the gas turbine 10 from corrosion by water, which may be sprayed on during operation due to the high flame velocity and flashback of the hydrogen.

Because of the thermal load capacity of the material composite 1 or of the heat shield 13, film cooling of the combustion chamber elements of the gas turbine 10 may be reduced compared to the prior art or dispensed with altogether. Film cooling is a process in which cool, unburned air is blown in through bore holes in the metallic lining of the combustion chamber. This cool air mixes with the hot gas. The temperature drops, and during combustion, undesirable byproducts such as carbon monoxide and unburned hydrocarbons are generated. On the other hand, the added air leads to combustion of the blended fuel-air mixture. This means that the mixture is richer because more nitrogen and oxygen are present. As a result, more harmful nitrogen oxides are produced. Due to the high thermal load capacity and an improved temperature insulation of the gas turbine 10 by the material composite 1 or the heat shield 13, the film cooling may be dispensed with or reduced, thus reducing the emission of pollutants. Because of the generally lower cooling requirement of the gas turbine 10 fewer passages for cooling fluid are required. This reduces the production costs of the gas turbine 10 and/or further increases the efficiency of the gas turbine 10.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A material composite comprising:
a first layer comprising a first ceramic material;
a second layer comprising a second ceramic material that is different from the first ceramic material; and
a bonding layer arranged between the first layer and the second layer, the bonding layer comprising a molybdenum-titanium carbide composite material,
wherein the first layer is connected to the second layer via the bonding layer.

2. The material composite of claim 1, wherein the bonding layer is in direct contact with both the first layer and the second layer.

3. The material composite of claim 1, wherein the bonding layer is connected both to the first layer and to the second layer by at least one cohesive bond, respectively.

4. The material composite of claim 3, wherein the bonding layer is connected to the first layer and/or the second layer by a direct cohesive bond.

5. The material composite of claim 1, further comprising:
a first diffusion barrier arranged between the first layer and the bonding layer,
a second diffusion barrier arranged between the second layer and the bonding layer; or
a combination of both the first diffusion barrier and the second diffusion barrier.

6. The material composite of claim 5, wherein the first diffusion barrier and/or the second diffusion barrier comprises aluminum oxide.

7. The material composite, of claim 5, wherein the first diffusion barrier is applied to the first layer by atomic layer deposition and/or the second diffusion barrier is applied to the bonding layer by atomic layer deposition.

8. The material composite of claim 1, wherein the first ceramic material is a ceramic fiber composite material comprising ceramic fibers on a ceramic matrix in which the ceramic fibers are embedded.

9. The material composite of claim 1, wherein the second ceramic material has a higher heat resistance, a higher corrosion resistance, or both a higher heat resistance and a higher corrosion resistance than the first ceramic material.

10. The material composite of claim 1, wherein the second ceramic material comprises yttrium-stabilized zirconium oxide.

11. A component comprising:
a carrier body; and
a material composite positioned on a surface of the carrier body, the material composite having:
a first layer comprising a first ceramic material;
a second layer comprising a second ceramic material that is different from the first ceramic material; and
a bonding layer arranged between the first layer and the second layer, the bonding layer comprising a molybdenum-titanium carbide composite material,
wherein the first layer is connected to the second layer via the bonding layer.

12. The component of claim 11, wherein the material composite is configured to provide a heat shield for the carrier body.

13. The component of claim 11, wherein the carrier body comprises a third material that is different from the first ceramic material and the second ceramic material.

14. A gas turbine comprising:
a component comprising:
a carrier body; and
a material composite positioned on a surface of the carrier body, the material composite having:
a first layer comprising a first ceramic material;
a second layer comprising a second ceramic material that is different from the first ceramic material; and
a bonding layer arranged between the first layer and the second layer, the bonding layer comprising a molybdenum-titanium carbide composite material,
wherein the first layer is connected to the second layer via the bonding layer.

15. A method for producing a material composite, the method comprising:
producing a first layer from of at least a first ceramic material;
producing a second layer from at least a second ceramic material that is different from the first ceramic material; and
connecting the first layer to the second layer by positioning a bonding layer between the first layer and the second layer, wherein the bonding layer comprises a molybdenum-titanium carbide composite material.

16. The method of claim 15, further comprising:
arranging a first diffusion barrier between the first layer and the bonding layer by atomic layer deposition; and/or
arranging a second diffusion barrier between the second layer and the bonding layer by atomic layer deposition.

17. The method of claim 16, wherein the first diffusion barrier and/or the second diffusion barrier comprises aluminum oxide.

18. The component of claim 13, wherein the third material is a metallic material.
